(19) United States
(12) Patent Application Publication
(10) Pub. No.: US 2014/0146528 A1
(43) Pub. Date: May 29, 2014

(54) Light Emitted Diode (LED) Rail Projection Lamp

(71) Applicant: BUCKINGHAM INDUSTRIAL CORPORATION, Jiangsu (CN)

(72) Inventor: Kuo-Chuan Lin, Taoyuan City (TW)

(73) Assignee: BUCKINGHAM INDUSTRIAL CORPORATION, Jiangsu (CN)

(21) Appl. No.: 13/727,232

(22) Filed: Dec. 26, 2012

(30) Foreign Application Priority Data
Nov. 26, 2012 (CN) 201210488650.6
Nov. 26, 2012 (CN) 201220633475.0

(51) Int. Cl. F21L 4/00

(52) U.S. Cl. CPC F21L 4/00
USPC 362/191

(57) ABSTRACT

A LED rail projection lamp is mounted slidably on a rail via a rail connector and includes a main body, a power source, a supporting member, a LED light bulb, a plastic member and a rail connector. The LED rail projection lamp. The supporting member has a first end mounted inside the main body, and a second end connected to the rail connector in such way that the supporting member is rotatable in a range of 0-355 degrees relative to the rail connector and in a range of 0-90 degrees relative to the main body. The LED rail projection lamp is simple in structure and neat-looking because all the fasteners are placed inside the main body and are not visible from outside.

### BACKGROUND OF THE INVENTION

1. Field of the Invention

The present invention relates to a lighting apparatus, especially relates to an LED rail projection lamp.

2. The Prior Arts

Rail lamps are a kind of commercial lighting apparatus, which is commonly used in shopping windows or exhibition booths as a spot light. Conventional LED rail projection lamps usually include a power source, a main body, a supporting member and heat radiating parts and etc. The supporting member is usually disposed outside of the main body, and is connected to the main body via screws or other fasteners to provide the rotating function of the rail lamps. The power source is usually placed outside of the main body in a power box. In such configuration, the connecting parts of the supporting member and the main body are usually directly exposed to exterior of the main body, and thereby affecting and hence decreasing the aesthetic appearance of the product. In addition, the power box not only increases the size of the rail lamps, but also lowers the integrity of the product. Furthermore, the heat radiating parts are separate elements from the main body of the rail lamps, thereby increasing the product cost.

### SUMMARY OF THE INVENTION

The primary purpose of the present invention is to provide an LED rail projection lamp with an integrated body. The goal is reached by installing the power source and supporting member inside the main body of the LED rail projection lamp, thereby eliminating the need of fasteners or other extra parts outside of the main body.

The LED rail projection lamp of the present invention includes: a main body where a LED light bulb is disposed; a supporting member having a first end mounted in the main body and a second end connected to a rail via a rail connector; and a power source placed inside the main body and electrically connected to said LED light bulb.

Preferably, the first end of the supporting member is pivotally connected to the main body in such way that the supporting member is rotatable from 0-90 degrees in the vertical direction relative to the main body.

Preferably, the second end of the supporting member is pivotally connected to the rail connector in such way that the supporting member is rotatable from 0-355 degrees in the horizontal direction relative to the rail connector.

Preferably, the LED light bulb is disposed at a first portion of the main body, and a plastic member is disposed inside a second portion of the main body. The second end of the supporting member is connected to the plastic member.

Preferably, the second portion end of the main body is formed with an opening and the plastic member has an outer surface formed with an insert slot in correspondence to the opening in the main body. The second end of the supporting member is inserted into the insert slot via the opening, and is pivotally connected to a rotation shaft formed on a wall surface defining the insert slot.

Preferably, the plastic member is disposed between the LED light bulb and the power source.

Preferably, a light reflector is disposed at the first portion of the main body, and is located in the light illuminating direction of the LED light bulb.

Preferably, the main body of the LED rail projection lamp is a hollow cylinder with an axial through hole in the axial direction.

Preferably, the main body of the LED rail projection lamp is manufactured from a thermal conductive material.

The LED rail projection lamp according to the present invention eliminates the need of a power box by placing the power source inside the lamp main body. The fasteners outside of the main body are also eliminated by mounting the supporting member inside the main body, for a better aesthetic appearance. In addition, the production cost is also lowered by merging the heat radiating function with the main body of the lamp to eliminate extra parts needed.

### BRIEF DESCRIPTION OF THE DRAWINGS

FIG. 1 is an exploded and perspective view showing a preferred embodiment of an LED rail projection lamp of the present invention;

FIG. 2 is a schematic and perspective view showing a supporting member employed in the LED rail projection lamp of the present invention shown in FIG. 1;

FIG. 3 is a schematic and perspective view showing a plastic member employed in the LED rail projection lamp of the present invention shown in FIG. 1; and

FIG. 4 is a schematic and perspective view showing the preferred embodiment of the LED rail projection lamp.

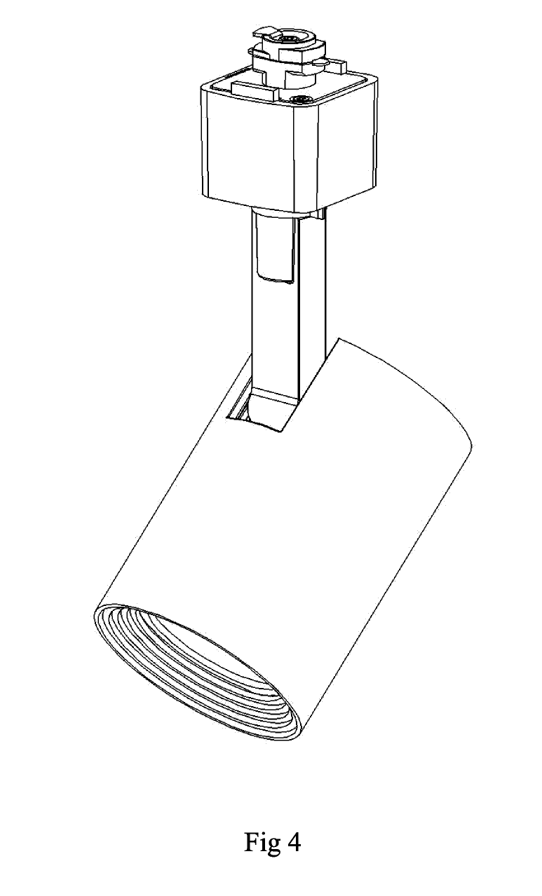

### DETAILED DESCRIPTION OF THE PREFERRED EMBODIMENT

The present invention will be apparent to those skilled in the art by reading the following detailed description of preferred embodiments thereof, with reference to the attached drawings.

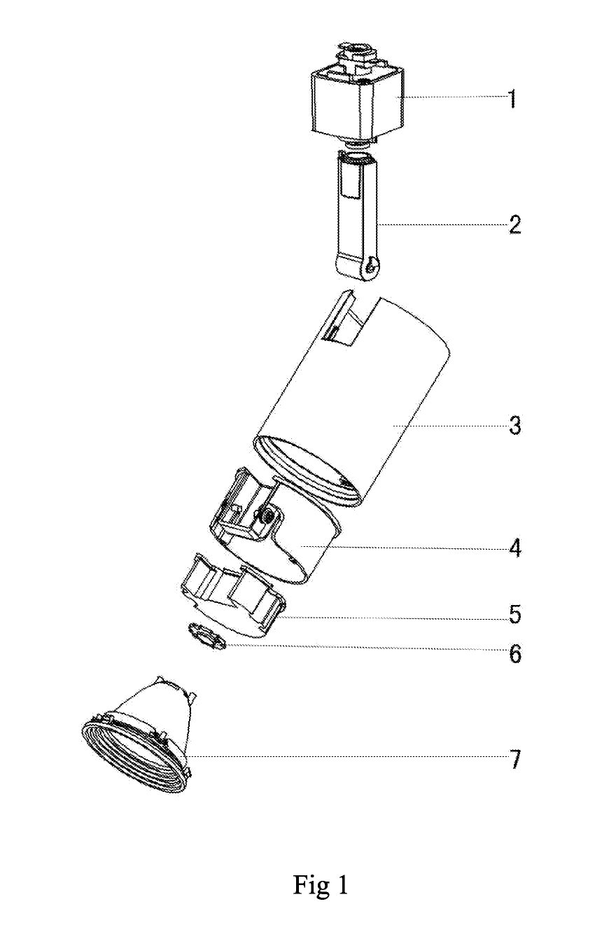

FIG. 1 is an exploded and perspective view showing a preferred embodiment of an LED rail projection lamp of the present invention. As shown in FIG. 1, the LED rail projection lamp of the present invention includes a rail connector 1, a supporting member 2, a main body 3, a plastic member 4, a power source 5, a LED light bulb 6 and a light reflector 7. An end of the rail connector 1 is installed slidably on a rail (not visible), and the supporting member 2 is connected to the other end of the rail connector to mount the LED lamp. The supporting member 2 is set up erectly with its second end (upper end as shown in FIG. 1) pivotally connected with the rail connector 1 such that the supporting member 2 is rotatable from 0-355 degrees in the horizontal direction relative to the rail connector 1. With the high degrees of rotation, the user can rotate the LED rail projection lamp to project the light at any desired location easily, thereby achieving a light projection in all directions. The supporting member 2 has a first end (lower end as shown in FIG. 1) pivotally connected to the main body 3 in such way that the supporting member 2 can rotate from 0-90 degrees in the vertical direction relative to the main body 3. In this way, the LED rail projection lamp of the present invention can project light to lower, higher or horizontal locations.

The main body 3 of the LED rail projection lamp is a hollow cylinder defining an axial through hole in its axial direction. The LED light bulb 6 is installed at the first portion of the main body 3, and the power source 5 is installed at the second portion of the main body 3, in which the power source 5 and the LED light bulb 6 are electrically connected to each other. By placing the power source 5 inside of the main body 3, the power box of the conventional LED rail lamp can be eliminated, thereby enhancing the integrity of the LED rail projection lamp. The second end of the main body is formed with an opening to permit mounting of or installation of the supporting member 2 inside the main body 3 through the opening. In addition, the main body 3 is made from or manufactured from a thermal conductive material, thereby merging the heat radiating function with the main body 3 and also eliminating the need of extra heat radiating parts.

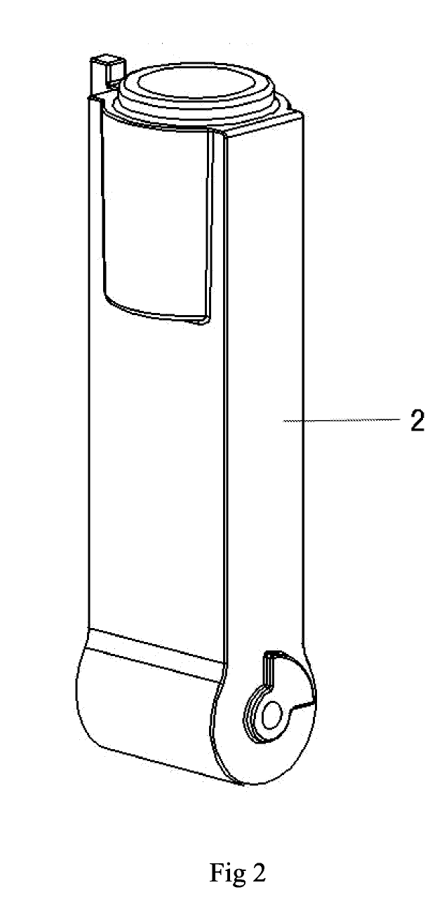

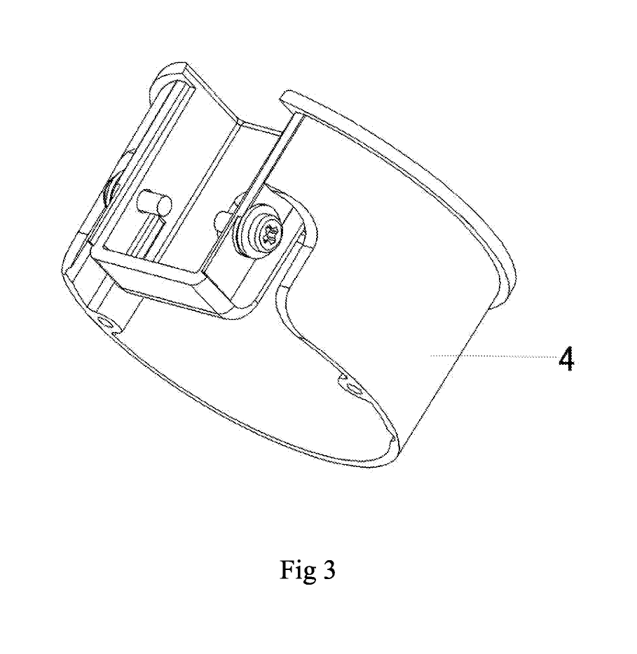

The plastic member 4 is disposed inside the main body 3 below the opening, and is located between the power source 5 and the LED light bulb 6. The LED light bulb 6 and the power source 5 are installed at the two separate ends of the plastic member 4, to avoid the heat generated by the LED light bulb 6 and the power source 5 from interfering with each other. As shown in FIG. 2 and FIG. 3, the plastic member 4 has an outer surface formed with an insert slot in correspondence to the position of the opening in the main body 3. The second end of the supporting member 2 is inserted into the insert slot through the opening, and is pivotally connected to a rotation shaft formed on a wall surface defining the insert slot of the plastic member 4. With such configuration, the fasteners of the LED rail projection lamp are not exposed, thereby enhancing an aesthetic appearance of the LED rail projection lamp of the present invention.

The light reflector 7 is installed at the first portion of the main body 3, and is located in the light illuminating direction of the LED light bulb 6. The light reflector 7 can focus the light illuminated from the LED light bulb 6, thereby decreasing the light loss.

The preferred embodiments described above are disclosed for illustrative purpose but to limit the modifications and variations of the present invention. Thus, any modifications and variations made without departing from the spirit and scope of the invention should still be covered by the scope of this invention as disclosed in the accompanying claims.

What is claimed is:

1. A light emitting diode (LED) rail projection lamp, comprising:
a main body with a LED light bulb disposed therein;
a supporting member having a first end mounted in said main body and a second end connected to a rail via a rail connector; and
a power source installed inside said main body and electrically connected to said LED light bulb.

2. The LED rail projection lamp as claimed in claim 1, wherein said first end of said supporting member is pivotally connected to said main body such that said supporting member is rotatable from 0-90 degrees in the vertical direction relative to said main body.

3. The LED rail projection lamp as claimed in claim 1, wherein said second end of said supporting member is pivotally connected to said rail connector such that said supporting member is rotatable from 0-355 degrees in the horizontal direction relative to said rail connector.

4. The LED rail projection lamp as claimed in claim 2, wherein said second end of said supporting member is pivotally connected to said rail connector such that said supporting member is rotatable from 0-355 degrees in the horizontal direction relative to said rail connector.

5. The LED rail projection lamp as claimed in claim 1, wherein said LED light bulb is disposed at a first portion of said main body, and a plastic member is disposed inside a second portion of said main body, in which, said second end of said supporting member is connected to said plastic member.

6. The LED rail projection lamp as claimed in claim 2, wherein said LED light bulb is disposed at a first portion of said main body, and a plastic member is disposed inside a second portion of said main body, in which, said second end of said supporting member is connected to said plastic member.

7. The LED rail projection lamp as claimed in claim 5, wherein said second portion of, said main body is formed with an opening, said plastic member having outer surface formed with an insert slot in correspondence to said opening; wherein, said second end of said supporting member is inserted into said insert slot via said opening in said main body, and is pivotally connected to a rotation shaft formed on a wall surface defining said insert slot.

8. The LED rail projection lamp as claimed in claim 6, wherein said second portion of, said main body is formed with an opening, said plastic member having outer surface formed with an insert slot in correspondence to said opening; wherein, said second end of said supporting member is inserted into said insert slot via said opening in said main body, and is pivotally connected to a rotation shaft formed on a wall surface defining said insert slot.

9. The LED rail projection lamp as claimed in claim 7, wherein said plastic member is disposed between said LED bulb and said power source.

10. The LED rail projection lamp as claimed in claim 8, wherein said plastic member is disposed between said LED bulb and said power source.

11. The LED rail projection lamp as claimed in claim 9, further comprising a light reflector disposed at said first portion of said main body and located in a light illuminating direction of said LED light bulb.

12. The LED rail projection lamp as claimed in claim 10, further comprising a light reflector disposed at said first portion of said main body and located in a light illuminating direction of said LED light bulb.

13. The LED rail projection lamp as claimed in claim 1, wherein said main body is a hollow cylinder defining an axial through hole in an axial direction.

14. The LED rail projection lamp as claimed in claim 11, wherein said main body is a hollow cylinder defining an axial through hole in an axial direction.

15. The LED rail projection lamp as claimed in claim 12, wherein said main body is a hollow cylinder defining an axial through hole in an axial direction.

16. The LED rail projection lamp as claimed in claim 1, wherein said main body is made from a thermal conductive material.

17. The LED rail projection lamp as claimed in claim 11, wherein said main body is made from a thermal conductive material.

18. The LED rail projection lamp as claimed in claim 12, wherein said main body is made from a thermal conductive material.
